(19) United States
(12) Patent Application Publication
(10) Pub. No.: US 2026/0338937 A1
(43) Pub. Date: Oct. 29, 2026

(54) SENSING SYSTEM, SENSING METHOD, AND RECORDING MEDIUM

(71) Applicant: Panasonic Intellectual Property Management Co., Ltd., Osaka (JP)

(72) Inventors: Takeshi NAKAYAMA, Hyogo (JP); Shoichi IIZUKA, Osaka (JP); Nobuyuki SHIRAKI, Hokkaido (JP)

(21) Appl. No.: 19/312,965

(22) Filed: Aug. 28, 2025

(30) Foreign Application Priority Data
Aug. 29, 2024 (JP) 2024-147755
Aug. 7, 2025 (JP) 2025-132364

(51) Int. Cl. G01S 13/04; G01S 7/41; G01S 13/00; G01S 13/46; G01S 13/87

(52) U.S. Cl. CPC G01S 13/04; G01S 7/411; G01S 13/003; G01S 13/46; G01S 13/87

(57) ABSTRACT

A sensing system for sensing a living body using a wireless signal that includes: a first subunit and a second subunit configured to be capable of mutually transmitting and receiving a wireless signal; an estimator that outputs first information regarding sensing of the living body; and a controller. The first subunit is configured to intercept a wireless signal that the second subunit uses to communicate with a wireless main unit, to obtain wireless information included in the wireless signal. The estimator outputs the first information based on the wireless information obtained. The controller performs predetermined control based on the first information output by the estimator.

### CROSS REFERENCE TO RELATED APPLICATIONS

The present application is based on and claims priority of Japanese Patent Application No. 2024-147755 filed on Aug. 29, 2024 and Japanese Patent Application No. 2025-132364 filed on Aug. 7, 2025. The entire disclosures of the above-identified applications, including the specifications, drawings and claims are incorporated herein by reference in their entirety.

### FIELD

The present disclosure relates to a sensing system, a sensing method, and a recording medium for accurately performing sensing of a living body.

### BACKGROUND

A method of using wireless signals is considered as a way to determine the presence, absence, and location of individuals. For example, PTL 1 discloses techniques of analyzing components including Doppler shift with the use of difference calculation to estimate the location or state of a person to be detected.

### CITATION LIST

### Patent Literature

PTL 1: Japanese Unexamined Patent Application Publication No. 2015-117972

### SUMMARY

### Technical Problem

When the techniques disclosed in PTL 1 are applied to Wi-Fi (registered trademark) devices, the sensing range is affected by the placement of the Wi-Fi main unit and Wi-Fi subunits, making it difficult to specify the sensing range with only the Wi-Fi subunits.

The present disclosure is conceived in view of the above circumstances and provides a sensing system capable of sensing the state of a living body with a simple configuration.

### Solution to Problem

A sensing system according to one aspect of the present disclosure is a sensing system for sensing a living body using a wireless signal, and includes: a first subunit and a second subunit configured to be capable of mutually transmitting and receiving a wireless signal; an estimator that outputs first information regarding sensing of the living body; and a controller. The first subunit is configured to intercept a wireless signal that the second subunit uses to communicate with a wireless main unit, to obtain wireless information included in the wireless signal. The estimator outputs the first information based on the obtained wireless information. The controller performs predetermined control based on the first information output by the estimator.

It should be noted that these general or specific aspects may be implemented by a system, an integrated circuit, a computer program, a computer-readable recording medium such as a CD-ROM, or any combination thereof.

### Advantageous Effects

With a sensing system according to the present disclosure, it is possible to provide a sensing system capable of sensing the state of a living body with a simple configuration.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram for explaining the outline of a sensing to Embodiment 1.

FIG. 2 is a diagram illustrating one example of the configuration of a sensing device according to Embodiment 1.

FIG. 3 is a flowchart illustrating one example of a sensing method employed by the sensing device according to Embodiment 1.

FIG. 4 is a diagram for explaining the outline of a sensing system according to Embodiment 2.

FIG. 5 is a diagram illustrating one example of the configuration of a sensing device according to Embodiment 2.

FIG. 6 is a flowchart illustrating one example of a sensing method employed by the sensing device according to Embodiment 2.

FIG. 7 is a diagram for explaining the outline of a sensing system according to a comparative example.

### DESCRIPTION OF EMBODIMENTS

(Underlying Knowledge Forming Basis of the Present Disclosure) A method of using wireless signals is considered as a way to sense a living body. The sensing of a living body refers to at least one of the following: detection of the presence or absence of a living body, positioning, distance measurement, posture detection, and personal identification.

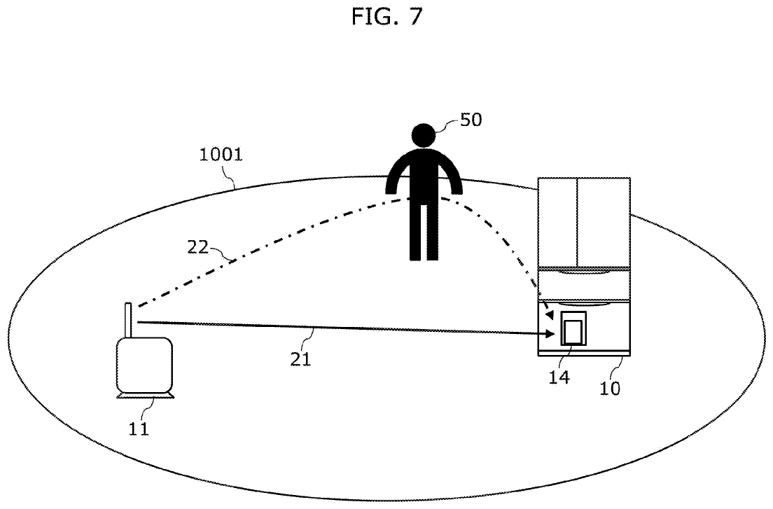

With the conventional techniques as disclosed in PTL 1, a transmission device that transmits wireless signals and a reception device that receives wireless signals perform sensing of a living body based on the assumption that channel state information (CSI) will be obtained. FIG. 7 is a diagram for explaining the outline of a sensing system according to a comparative example. As illustrated in FIG. 7, in the sensing system according to the comparative example, sensing range 1001 is an elliptical space that includes the space between wireless main unit 11 and subunit 14. For this reason, sensing range 1001 depends on the placement of wireless main unit 11 and subunit 14, and when the position of wireless main unit 11 is unknown, the problem is that sensing range 1001 cannot be defined with subunit 14 alone.

The above-described problem will be explained in detail. When sensing of a living body is performed using CSI in Wi-Fi communication, subunit 14 obtains CSI from a signal from wireless main unit 11 to subunit 14. In this case, if a living body is present on the wireless transmission path between wireless main unit 11 and subunit 14, since an influence caused by a living body (biological components) is superimposed on the CSI, it is possible to perform biological sensing by analyzing changes in the CSI to estimate the presence or state of the living body, When wireless main unit 11 and subunit 14 are provided in an open space with less wireless reflection, the sensing range is an elliptical space centered on the positions of wireless main unit 11 and subunit 14. Accordingly, if the positions of wireless main unit 11 and subunit 14 are defined, the sensing range can be also defined. However, when the position of wireless main unit 11 is unknown, for example, the sensing range cannot be clearly defined, and there is a risk that sensing accuracy or reliability may decrease.

In view of this, the inventors have applied a configuration in which two subunits are mounted on a single device or respectively mounted on two devices. This has led to the discovery of a configuration that enables wireless sensing with one or two sensing devices and defines the sensing range using inexpensive wireless chips.

A sensing system according to a first aspect of the present disclosure is a sensing system for sensing a living body using a wireless signal and includes: a first subunit and a second subunit configured to be capable of mutually transmitting and receiving a wireless signal; an estimator that outputs first information regarding sensing of the living body; and a controller. The first subunit is configured to intercept a wireless signal that the second subunit uses to communicate with a wireless main unit, to obtain wireless information included in the wireless signal. The estimator outputs the first information based on the wireless information obtained. The controller performs predetermined control based on the first information output by the estimator.

Since this enables the first subunit to intercept communication between the wireless main unit and the second subunit to obtain wireless information, and output first information regarding the state of a living body, highly accurate sensing can be performed with a simple configuration.

A sensing system according to a second aspect of the present disclosure is the sensing system according to the first aspect of the present disclosure, and the first subunit and the second subunit are provided in a single device.

As a result, by mounting two subunits on a single device, the device can determine the sensing range on its own, allowing for high installation flexibility and easy operation.

A sensing system according to a third aspect of the present disclosure is the sensing system according to the first or second aspect of the present disclosure, and the wireless information includes: information to be transmitted from the second subunit to the first subunit; and information to be transmitted from the second subunit to the first subunit via the living body.

As a result, by utilizing wireless information based on both direct waves and biological reflected waves, it is possible to more accurately capture an influence caused by a living body and improve sensing accuracy.

A sensing system according to a fourth aspect of the present disclosure is the sensing system according to any one of the first to third aspects of the present disclosure, and the first information includes sensing information regarding the state of the living body,

This enables not only simple presence detection, but also a variety of biological sensing functions such as positioning and posture determination by including, as first information, sensing information regarding the state of a living body.

A sensing system according to a fifth aspect of the present disclosure is the sensing system according to any one of the first to fourth aspects of the present disclosure and further includes the wireless main unit. The wireless main unit is configured to be capable of transmitting a wireless signal to each of the first subunit and the second subunit.

This enables signals to be transmitted from the wireless main unit to each subunit, thereby facilitating collaboration with external networks and expansion of the sensing range. It also makes it easy to unify the channel settings for each subunit to the same channel.

A sensing system according to a sixth aspect of the present disclosure is the sensing system according to the fifth aspect of the present disclosure. The first subunit is configured to obtain wireless information from each of the wireless main unit and the second subunit. The estimator obtains the first information based on a first sensing range and a second sensing range, where the first sensing range corresponds to the first subunit and the wireless main unit, and the second sensing range corresponds to the first subunit and the second subunit.

As a result, by obtaining wireless information from the wireless main unit and the second subunit to use information based on the sensing range of each subunit, it is possible to expand the sensing range or improve sensing accuracy.

A sensing system according to a seventh aspect of the present disclosure is the sensing system according to any one of the first to sixth aspects of the present disclosure. The estimator includes a sensing unit and a condition determiner. The sensing unit is configured to output sensing information based on the wireless information. The condition determiner determines whether the sensing information output by the sensing unit satisfies a predetermined condition. The first information includes information corresponding to a determination result obtained by the condition determiner.

This enables the estimator, equipped with the sensing unit and the condition determiner, to flexibly determine information according to changes in the state of a living body and perform accurate control based on the determination results.

A sensing system according to an eighth aspect of the present disclosure is the sensing system according to the seventh aspect of the present disclosure. The estimator includes a state change extractor that extracts a change in the state of the living body in an operating state. The sensing unit is configured to output sequential sensing information that is the sensing information in the operating state. The state change extractor extracts, as state change information, a difference between the sequential sensing information and reference sensing information that is the sensing information in a reference state. The first information includes the state change information.

As a result, by extracting differences in sensing information between the reference state and the operating state to obtain state change information, it is possible to detect changes in the state of a living body with high accuracy and perform control that responds to movement.

A sensing method according to a ninth aspect of the present disclosure is a sensing method to be executed by a sensing system for sensing a living body using at least one processor, where the sensing system includes a first subunit and a second subunit configured to be capable of mutually transmitting and receiving a wireless signal. The sensing method includes: outputting first information regarding sensing of the living body; intercepting a wireless signal that the second subunit uses to communicate with a wireless main unit, to obtain wireless information included in the wireless signal; outputting the first information based on the obtained wireless information; and performing predetermined control based on the output first information.

As a result, since it is possible to obtain wireless information using communication between two subunits without using a wireless main unit, and output first information regarding the state of a living body, highly accurate sensing can be performed with a simple configuration.

A recording medium according to a tenth aspect of the present disclosure is a non-transitory computer-readable recording medium having a program stored therein, the program causing at least one computer to execute the sensing method according to the ninth aspect of the present disclosure.

It should be noted that the present disclosure can be implemented not only as a device, but also as an integrated circuit including processing means included in such a device, as a method including, as steps, processes performed by the processing means included in the device, as a program causing a computer to execute these steps, or as information, data or signals indicating the program. These program, information, data, and signals may be distributed via recording media such as a CD-ROM or communication media such as the Internet.

Hereinafter, embodiments of the present disclosure will be described with reference to the drawings. Note that the embodiments described below each show one preferable specific example of the present disclosure. The numeral values, shapes, materials, elements, arrangement and connection of elements, steps, an order of steps, etc., indicated in the following embodiments are mere examples and are not intended to limit the scope of the present disclosure. Among elements described in the following embodiment, those not described in any of the independent claims presenting the broadest concept of the present disclosure are described as optional elements composing a preferable form. In the present specification and drawings, elements with a substantially same functional configuration share like reference signs so that redundant description is omitted.

### Embodiment 1

An embodiment will describe a method of sensing a living body using a multiple-input multiple-output (MIMO) method in which both the number of transmission antennas and the number of reception antennas are plural. The configuration of the present disclosure is likewise applicable to a single-input multiple-output (SIMO) method and a multiple-input single-output (MISO) method in which either of the number of transmission antennas and the number of reception antennas is plural, and a single-input single-output (SISO) method in which both the number of transmission antennas and the number of reception antennas is one.

### [Configuration]

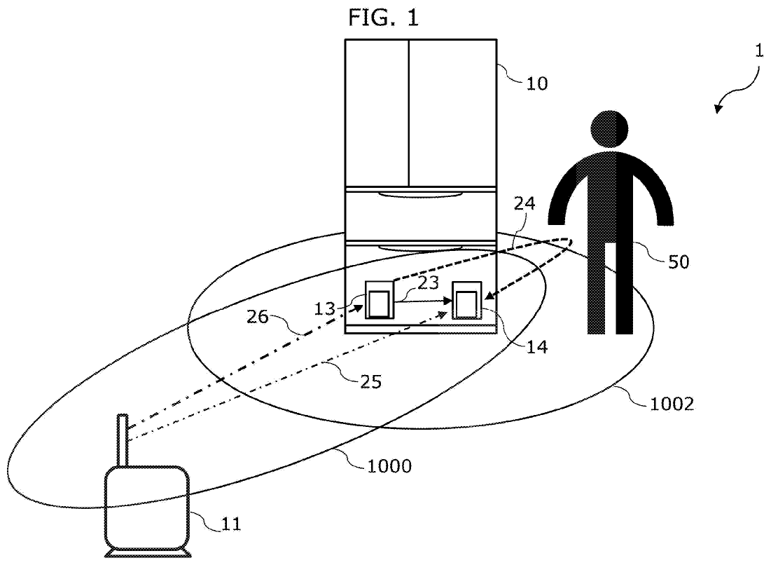

FIG. 1 is a diagram illustrating the overall configuration of sensing system 1 according to Embodiment 1.

Specifically, FIG. 1 illustrates sensing device 10, wireless main unit 11, subunit 13, subunit 14, living body 50, and direct wave 23, reflected wave 24 reflected by living body 50, communication 25 from wireless main unit 11 to subunit 14, and communication 26 from wireless main unit 11 to subunit 13 among communications from subunit 13 to subunit 14, and sensing ranges 1000 and 1002 of wireless sensing.

Sensing system 1 includes, for example, sensing device 10 among these components. Sensing device 10 is placed within a range where sensing is desired (i.e., a range in which sensing is to be performed). Sensing device 10 is a radio device capable of at least transmitting and receiving wireless signals by including subunit 13 and/or subunit 14.

Sensing device 10, although not shown in FIG. 1, may have, for example, functions other than a radio as functional components. Sensing device 10 is, for example, a refrigerator. Sensing device 10 is not limited to refrigerators and may be home appliances such as televisions and washing machines, as well as shared printers in offices, desks in shared conference spaces, or even portable devices like smartphones.

Wireless main unit 11 is, for example, a device that has an access point function. Sensing range 1002 is a space in which sensing of living body 50 can be performed by sensing device 10 and wireless main unit 11 and is a space in which the sensing is to be performed.

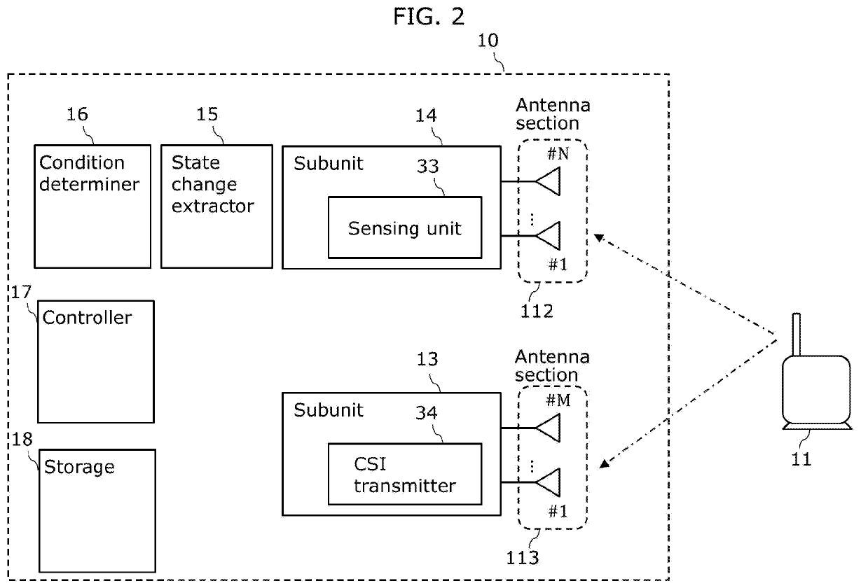

FIG. 2 is a block diagram illustrating one example of the configuration of the sensing device according to Embodiment 1. In FIG. 2, sensing device 10 includes subunit 13, antenna section 113, subunit 14, antenna section 112, state change extractor 15, condition determiner 16, controller 17, and storage 18. Subunit 14 includes sensing unit 33. Subunit 13 includes CSI transmitter 34. In the present embodiment, subunit 13 operates as a wireless subunit for wireless main unit 11 and as a wireless main unit for subunit 14. Subunit 14 is provided in the same device (sensing device 10) as the device in which subunit 13 is provided.

Sensing device 10 is, for example, capable of wireless communication via Wi-Fi. Sensing device 10 has subunit 13 and subunit 14 built in. In sensing device 10, subunit 14 or subunit 13 is connected (joined) to wireless main unit 11 and transmits and receives wireless signals to and from wireless main unit 11. The term “joined” used herein means a state in which subunit 14 or subunit 13 is connected to the access point of wireless main unit 11 by a connection procedure in the Wi-Fi network. In FIG. 1, subunit 13 and subunit 14 are illustrated outside of the housing of sensing device 10 for easy understanding of the configuration of sensing device 10, but these subunits may be actually placed in the housing of sensing device 10.

Wireless main unit 11 is capable of transmitting wireless signals via Wi-Fi. Wireless main unit 11 has a Wi-Fi access point function and transmits, for instance, beacon signals using prestored SSIDs. Wireless main unit 11 accepts connection requests from Wi-Fi subunits and has a function to authorize and manage the connection. Specifically, wireless main unit 11 receives signals transmitted from wireless subunits such as subunit 13 and subunit 14 and performs communication processing based on the Wi-Fi standard. In this embodiment, Wi-Fi has been given as an example of a wireless system, but it is obvious that any wireless system, such as RSSI or CSI, capable of conveying wireless conditions can be applied.

Subunit 13 has antenna section 113 and CSI transmitter 34. Subunit 13 joins wireless main unit 11 via antenna section 113 and can receive wireless signals via Wi-Fi from wireless main unit 11. Subunit 13 may be communicable with subunit 14 without joining wireless main unit 11.

Subunit 13 is capable of transmitting wireless signals from CSI transmitter 34 to subunit 14. Stated differently, communication is possible where subunit 13 functions as a wireless main unit and subunit 14 functions as a wireless subunit. Specifically, subunit 13 transmits either a signal transmitted to subunit 14 or a signal transmitted via broadcast. More specifically, subunit 13 transmits predefined types of packets such as beacon signals, Acknowledgment (ACK), Null Data Packet (NDP), NULL, and data packets. Subunit 13 is one example of a second subunit. Received Signal Strength Indicator (RSSI) and CSI are examples of wireless information.

Antenna section 113 includes wireless antennas provided for subunit 13. In the figure, M antennas are illustrated and M is a natural number greater than or equal to 1. In other words, the number of antennas in antenna section 113 may be one or plural.

CSI transmitter 34 transmits wireless signals via antenna section 113, The wireless signals transmitted by CSI transmitter 34 include, for example, predetermined types of packets such as beacon signals, ACK, NDP, NULL, and data packets, and are transmitted to wireless main unit 11 or subunit 14.

Subunit 14 has antenna section 112 and sensing unit 33. Subunit 14 joins wireless main unit 11 via antenna section 112 and can receive wireless signals via Wi-Fi from wireless main unit 11. Subunit 14 may be communicable with subunit 13 without joining wireless main unit 11.

Subunit 14 obtains at least RSSI or CSI from a signal received from either a signal that CSI transmitter 34 in subunit 13 transmits to wireless main unit 11, a signal CSI transmitter 34 transmits to subunit 14, or a signal transmitted via broadcast. More specifically, subunit 14 obtains at least RSSI or CSI when receiving, as direct wave 23 or reflected wave 24 of the communication, predefined types of packets such as beacon signals, ACK, NDP, NULL, and data packets from subunit 13 via antenna section 112.

For example, subunit 14 may intercept a wireless signal that subunit 13 uses to communicate with wireless main unit 11. Interception is to receive a wireless signal transmitted for another wireless device. In this case, the band and channel of wireless signals receivable by subunit 14 are set to the same band and channel as those used in wireless communication with subunit 13 and wireless main unit 11. In other words, subunit 14 can receive a wireless signal transmitted for another wireless device if the band and channel of the received wireless signal are the same as the band and channel of a transmitted wireless signal. Subunit 14 is one example of a first subunit. RSSI and CSI are examples of wireless information.

Antenna section 112 includes wireless antennas provided for subunit 14. In the figure, N antennas are illustrated and N is a natural number greater than or equal to 1. In other words, the number of antennas in antenna section 112 may be one or plural.

Sensing unit 33 extracts biological components from a reception signal using at least RSSI or CSI obtained from direct wave 23 or reflected wave 24 obtained by antenna section 112. Sensing unit 33 performs sensing that includes at least one of detection of the presence or absence of a living body, positioning, distance measurement, posture detection, or personal identification, using Multiple SIgnal Classification (MUSIC) method, beamforming method, Capon method, and other known methods, and outputs the result of the sensing as sensing information. The sensing information indicates states regarding a living body within sensing range 1002. The sensing unit is one example of an estimator. The sensing information is one example of first information that indicates states regarding a living body.

State change extractor 15 extracts changes in state in sensing range 1002 between a reference state and an operating state, based on sensing information output by sensing unit 33. Here, changes in the state are detected when there is a difference between reference sensing information obtained in the reference state and sequential sensing information obtained in the operating state. Specifically, in the reference state such as unmanned state or steady state after sensing device 10 is installed, antenna section 112 previously obtains reference wireless information including at least RSSI or CSI, and sensing unit 33 generates reference sensing information based on the reference wireless information and stores the reference sensing information in storage 18. In the operating state, however, antenna section 112 obtains sequential wireless information including at least RSSI or CSI, and sensing unit 33 generates sequential sensing information and likewise stores the sequential sensing information in storage 18. State change extractor 15 then detects changes in state within sensing range 1002 based on the difference between the reference sensing information and the sequential sensing information, and outputs the results as state change information. State change extractor 15 is one example of an estimator. The state change information is one example of first information.

Condition determiner 16 determines whether the sequential sensing information output by sensing unit 33 or the state change information calculated by state change extractor 15 satisfies a predetermined condition that has been set in advance. The predetermined condition is whether the total sum of the distance between wireless main unit 11 and a living body and the distance between subunit 13 and living body 50, within sensing range 1002, is greater than or equal to a predetermined threshold value when such a total sum is obtained. This determination result is used for determining the execution contents of control by controller 17 described later. When state change information is determinable by condition determiner 16, for example, condition determiner 16 may apply a predetermined condition to the state change information and perform determination. The number of predetermined conditions used for determination may be one or plural. The predetermined condition may be stored in storage 18 in advance or set by the user. Specifically, information set by the user may be obtained via subunit 13 or subunit 14, or via sensing device 10. Condition determiner 16 is one example of an estimator.

Controller 17 performs predetermined control based on the determination result obtained by condition determiner 16. Specifically, controller 17 performs predetermined control such as starting, stopping, or changing the predetermined operation of a control target (home appliance), based on whether the sequential sensing information or state change information satisfies the predetermined condition.

In the case of controlling the brightness of the display of a home appliance, for example, when the sensing result indicates that there are people present in the sensing range, control can be performed to increase the brightness of the display, and when there are no people present in the sensing range, control can be performed to decrease the brightness of the display. This can reduce unnecessary power consumption when there are no people present.

Moreover, it is possible to inhibit unnecessary notification by sending a notification only when there are people present in the sensing range.

The contents of predetermined control may be determined based on control information stored in storage 18 in advance or set by the user. The control contents set by the user may be obtained via subunit 13 or subunit 14 after having been sent to sensing device 10 via wireless main unit 11.

Storage 18 stores, for instance, various parameters for use in each block in sensing device 10, processing results, and condition information indicating predetermined conditions. Storage 18 includes, for instance, non-volatile memory such as flash memory.

Sensing device 10 may include a processor, and by the processor executing a program stored in storage 18, a function corresponding to each block such as CSI transmitter 34, subunit 13, subunit 14, sensing unit 33, state change extractor 15, condition determiner 16, or controller 17 may be realized by software.

### [Operation]

Next, the operation of sensing device 10 according to Embodiment 1 will be described.

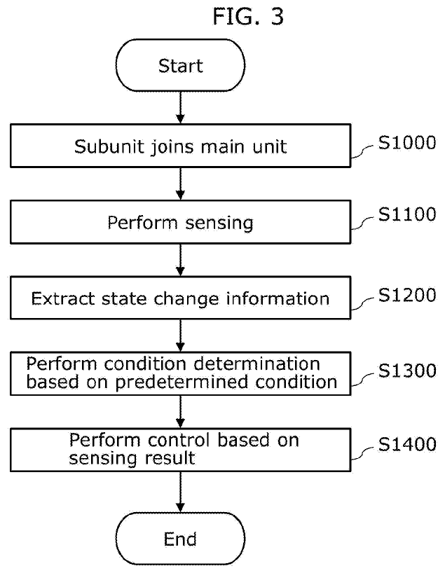

FIG. 3 is a flowchart illustrating one example of a sensing method employed by the sensing device according to Embodiment 1.

First, subunit 13 and subunit 14 each join wireless main unit 11 (S1000). Specifically, in the joining, each of subunit 13 and subunit 14 transmits a connection request to the access point of wireless main unit 11, and after the authentication and connection process, a communicable relationship is established over the network. This brings subunit 13 and wireless main unit 11 or subunit 14 and wireless main unit 11 into a communicable state.

Subsequently, when subunit 13 and subunit 14 are each communicable with wireless main unit 11 that is the same main unit, subunit 13 and subunit 14 may be subunits that are communicable with each other. In this case, subunit 13 operates as a wireless subunit when communicating with wireless main unit 11 and operates as a wireless main unit when communicating with subunit 14. In other words, in this case, the relationship between subunit 13 and subunit 14 is a relationship in which subunit 13 operates as a wireless main unit and subunit 14 operates as a wireless subunit. Alternatively, subunit 13 may operate as a wireless subunit and subunit 14 may operate as a wireless main unit. Subunit 13 and subunit 14, whose communication has been enabled, can mutually transmit and receive signals. Subunit 13 and subunit 14 may be connectable without one of subunit 13 and subunit 14 joining wireless main unit 11. Subunit 13 and subunit 14 may be connectable without both subunit 13 and subunit 14 joining the wireless main unit.

Subsequently, sensing device 10 performs sensing in sensing range 1002 (S1100). Specifically, subunit 14 receives wireless information (e.g., reception information) from subunit 13 via antenna section 112 and obtains at least RSSI or CSI from the received signal. Sensing unit 33 then outputs the state of a living body within sensing range 1002 as sensing information (sequential sensing information), based on at least the obtained RSSI or CSI. The state of a living body is at least one of detection of the presence or absence of a living body, positioning, distance measurement, posture detection, or personal identification.

Sensing device 10 extracts changes in state regarding a living body within sensing range 1002 (S1200). Specifically, state change extractor 15 reads out, from storage 18, reference sensing information previously stored in storage 18. The reference sensing information is sensing information obtained by performing sensing in sensing range 1002 in the reference state. Sensing device 10 then calculates the difference between the sequential sensing information output in step S1100 and the reference sensing information and extracts, as state change information, state changes indicated by the difference.

Sensing device 10 references the sequential sensing information output in step S1100 or the state change information extracted in step S1200 and performs condition determination based on a predetermined condition (S1300). Specifically, using a predetermined condition previously stored in storage 18, condition determiner determines whether the sequential sensing information or state change information satisfies the predetermined condition.

When the distance from sensing device 10 to the living body within sensing range 1002 (first information) can be obtained as sequential sensing information, for example, condition determiner 16 determines whether the distance indicated by the sensing information that has been output is greater than or equal to a threshold value, based on the predetermined condition. Condition determiner 16 may determine whether state change extractor 15 has extracted that the distance indicated by the output sensing information has changed from the state in which the distance exceeds the threshold value to the state in which the distance is less than or equal to the threshold value. In other words, condition determiner 16 may determine whether the distance of the living body has changed from being greater than or equal to the threshold value to being less than or equal to the threshold value. When the state of the presence or absence of the living body within sensing range 1002 (first information) can be obtained as the output sensing information, condition determiner 16 determines whether the state indicated by the output sensing information indicates the presence of the living body. Condition determiner 16 may determine whether state change extractor 15 has extracted that the state has changed from the state in which the living body is absent to the state in which the living body is present, i.e., whether the state has changed from being absent to being present.

The first information is based on wireless information. Specifically, the first information is based on at least RSSI or CSI. The first information may be information output depending on sensing information based on at least RSSI or CSI, e.g., state change information. The first information is output by an estimator realized by sensing unit 33, state change extractor 15, or condition determiner 16, but may be information calculated in the middle of output, e.g., sensing information. In other words, the state change information and the sensing information are examples of first information.

Sensing device 10 performs predetermined control based on the result of the condition determination (sensing result) in step S1300 (S1400). Specifically, controller 17 performs control of sensing device 10 based on the determination result of the condition determination. When condition determiner 16 determines that a living body is present in sensing range 1002 in step S1300, for example, controller 17 performs predetermined control that is first control. When condition determiner 16 determines that there is no living body in sensing range 1002, however, controller 17 performs second control different from the first control.

Here, control of increasing the brightness of the display of a home appliance is raised as one example of the first control. Control of decreasing the brightness of the display or control of not sending any notifications is raised as examples of the second control. This enables power-saving operations based on the user's presence and suppression of unnecessary notifications. Thus, the second control may be more power-saving compared to the first control.

### [Advantageous Effects, Etc.]

Sensing system 1 according to the present embodiment is a sensing system for sensing a living body using a wireless signal. Sensing device 10 includes subunit 13 (a second subunit), subunit 14 (a first subunit), sensing unit 33, state change extractor 15, condition determiner 16 (an estimator), and controller 17. Subunit 13 and subunit 14 are capable of mutually transmitting and receiving a wireless signal. The estimator outputs first information regarding sensing of a living body. Subunit 14 intercepts a wireless signal that subunit 13 uses to communicate with wireless main unit 11, to obtain wireless information included in the wireless signal. The estimator outputs first information based on the obtained wireless information. Controller 17 performs predetermined control based on the first information output by the estimator.

Since this enables subunit 14 to intercept communication between wireless main unit 11 and subunit 13 to obtain wireless information, and output first information regarding the state of a living body, it is possible to perform highly accurate sensing with a simple configuration.

In sensing system 1 according to the present embodiment, subunit 13 and subunit 14 are provided in a single sensing device 10.

By mounting two subunits 13 and 14 on a single sensing device 10, sensing device 10 can identify the sensing range on its own, allowing for high installation flexibility and ease of operation.

In sensing system 1 according to the present embodiment, the wireless information includes information (direct wave) to be transmitted from subunit 13 to subunit 14 and information (biological reflected wave) to be transmitted from subunit 13 to subunit 14 via the living body.

As a result, by utilizing wireless information based on both direct waves and biological reflected waves, it is possible to more accurately capture an influence caused by a living body and improve sensing accuracy.

In sensing system 1 according to the present embodiment, the first information includes sensing information regarding the state of the living body.

As a result, by including sensing information regarding the state of a living body as first information, not only simple presence detection, but also a variety of biological sensing functions such as positioning and posture determination can be achieved.

Sensing system 1 according to the present embodiment further includes wireless main unit 11. Wireless main unit 11 is configured to be capable of transmitting a wireless signal to each of subunit 13 and subunit 14.

This enables signals to be transmitted from wireless main unit 11 to each subunit 13, 14, thereby facilitating collaboration with external networks and expansion of the sensing range. It also makes it easy to unify the channel settings for each subunit 13, 14 to the same channel.

In sensing system 1 according to the present embodiment, the estimator includes sensing unit 33 and condition determiner 16. Sensing unit 33 is configured to output sensing information based on the wireless information. Condition determiner 16 determines whether the sensing information output by sensing unit 33 satisfies a predetermined condition. The first information includes information corresponding to the determination result obtained by condition determiner 16.

This enables the estimator, equipped with sensing unit 33 and condition determiner 16, to flexibly determine information in accordance with changes in the state of the living body and perform accurate control based on the determination result.

In sensing system 1 according to the present embodiment, the estimator includes state change extractor 15 that extracts a change in the state of the living body in an operating state. Sensing unit 33 is configured to output sequential sensing information that is the sensing information in the operating state. State change extractor 15 extracts, as state change information, the difference between the sequential sensing information and reference sensing information that is the sensing information in a reference state. The first information includes the state change information.

As a result, by extracting a difference in sensing information between the reference state and the operating state to obtain state change information, it is possible to detect changes in the state of a living body with high accuracy and perform control that responds to movement.

### Variation of Embodiment 1

In the present embodiment, sensing device 10 performs sensing using wireless signals obtained only from sensing range 1002, but may receive respective wireless information items from sensing ranges and output first information based on the wireless information items obtained through the reception. Specifically, sensing device 10 may receive wireless information obtained using wireless signals from sensing range 1000, receive wireless information corresponding to each of sensing range 1000 and sensing range 1002, and based on the wireless information corresponding to sensing range 1000 and the wireless information corresponding to sensing range 1002, output first information that is sensing information.

Thus, in sensing system 1, subunit 14 obtains wireless information from each of wireless main unit 11 and subunit 13. The estimator obtains first information based on sensing range 1000 (first sensing range) corresponding to subunit 14 and wireless main unit 11 and sensing range 1002 (second sensing range) corresponding to subunit 14 and subunit 13.

According to the above configuration, sensing device 10 can output a plurality of sensing information items based on sensing ranges 1000 and 1002. As a result, compared to sensing information based on a single sensing range, it is possible to increase the amount of information in sensing information or expand the sensing range, which is expected to improve the accuracy of sensing living body 50. Furthermore, owing to the sensing information based on sensing ranges 1000 and 1002, the accuracy of the results of the determination performed under a predetermined condition using first information is improved, enabling the provision of a sensing device that can achieve more appropriate control.

### Embodiment 2

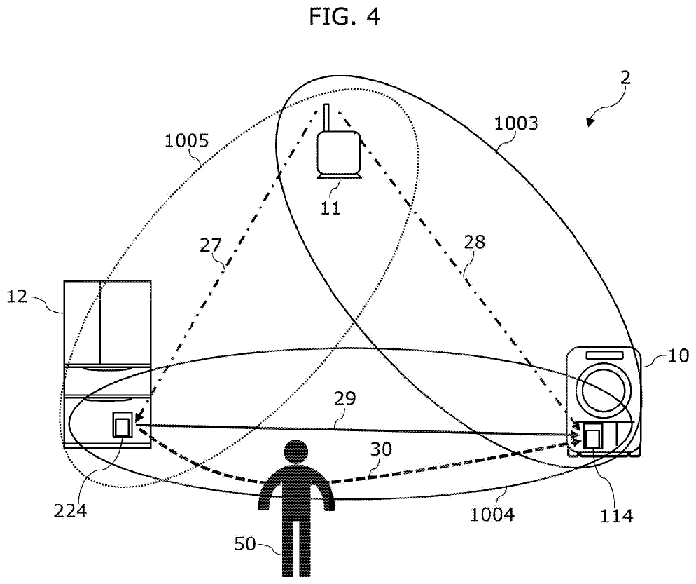

FIG. 4 is a diagram illustrating the outline of sensing system 2 according to Embodiment 2.

Specifically, FIG. 4 illustrates sensing device 12, sensing device 10, wireless main unit 11, wireless unit 114, wireless unit 224, direct wave 27 of the communication from wireless main unit 11 to sensing device 12, direct wave 28 of the communication from wireless main unit 11 to sensing device 10, direct wave 29 from sensing device 12 to sensing device 10, reflected wave 30 from wireless main unit 11 to sensing device 10 via living body 50, sensing range 1003 of wireless sensing using wireless main unit 11 and sensing device 10, and sensing range 1004 of wireless sensing using sensing device 10 and sensing device 12. In the following description, description overlapping the description of Embodiment 1 will be omitted. Wireless main unit 11 is a wireless main unit connectable to indoor networks in a room where sensing device 10 is provided or external networks.

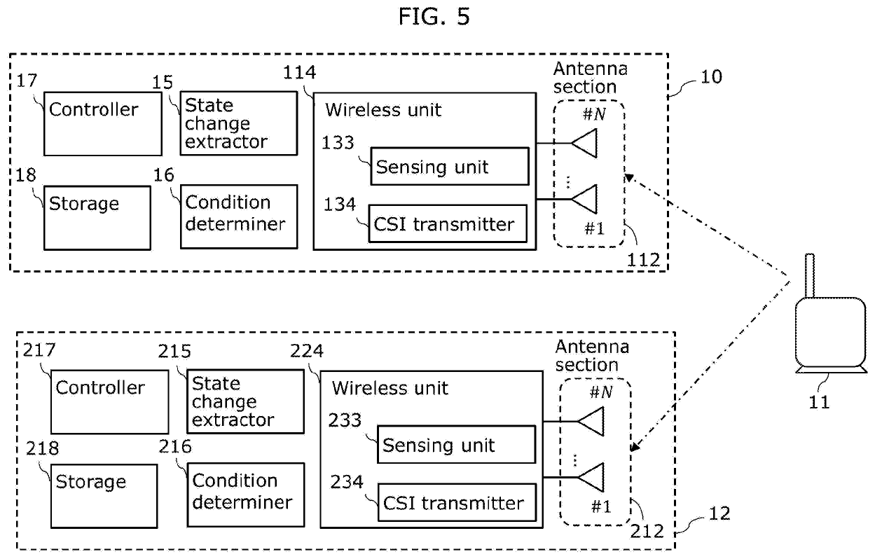

FIG. 5 is a block diagram illustrating the configuration of the sensing device according to Embodiment 2. In FIG. 5, sensing device 10 includes antenna section 112, wireless unit 114, state change extractor 15, condition determiner 16, controller 17, and storage 18. Wireless unit 114 includes sensing unit 133 and CSI transmitter 134. Sensing device 12 includes antenna section 212, wireless unit 224, state change extractor 215, condition determiner 216, controller 217, and storage 218. Wireless unit 224 includes sensing unit 233 and CSI transmitter 234. Wireless main unit 11 is a body different from sensing device 10 and sensing device 12.

In Embodiment 2, sensing device 12 is added to the configuration of the sensing system according to Embodiment 1. With sensing device 10 and sensing device 12 respectively joining wireless main unit 11, sensing device 10 enables communication with the outside of sensing system 2.

In FIG. 4 and FIG. 5, wireless unit 114 and wireless unit 224 are arranged as different bodies, but the functionality of these wireless units may be implemented in a single wireless chip or wireless module.

In sensing system 2 according to Embodiment 2 illustrated in FIG. 5, CSI transmitter 134 is added to the configuration of sensing device 10 according to Embodiment 1 illustrated in FIG. 2, Sensing system 2 is configured by adding, to sensing system 1, sensing device 12 having the same configuration as sensing device 10 according to Embodiment 2. Sensing device 12 according to Embodiment 2, like sensing device 10 according to Embodiment 1, performs sensing based on at least RSSI or CSI obtained from CSI transmitter 234 of sensing device 12, and controller 217 performs control based on the sensing result obtained through the sensing.

Sensing device 10 includes antenna section 112, wireless unit 114, state change extractor 15, condition determiner 16, controller 17, and storage 18. The operation in each functional block will be described later.

Sensing device 12 includes antenna section 212, wireless unit 224, state change extractor 215, condition determiner 216, controller 217, and storage 218. The operation in each functional block will be described later.

Wireless unit 114 joins wireless main unit 11 via antenna section 112 and can transmit or receive wireless signals via Wi-Fi to and from wireless main unit 11. Wireless unit 114 may be communicable with wireless unit 224 of sensing device 12 without joining wireless main unit 11. Wireless unit 114 obtains at least RSSI or CSI from a signal received from CSI transmitter 234 in wireless unit 224 of sensing device 12.

Sensing unit 133 performs sensing based on at least the obtained RSSI or CSI and outputs sensing information based on the sensing result obtained through the sensing. State change extractor 15 extracts changes in state within sensing range 1004 based on the sensing information, and the extracted information serves as state change information (an example of first information),

State change extractor 15 extracts changes in state within sensing range 1003 or 1004 between the reference state and the operating state, based on the sensing information output by sensing unit 133. Here, the changes in the state are detected when there is a difference between the reference sensing information obtained in the reference state and the sequential sensing information obtained in the operating state, Specifically, in the reference state such as unmanned state or steady state after sensing device 10 is installed, antenna section 112 obtains reference wireless information including at least RSSI or CSI, and sensing unit 133 generates reference sensing information based on the wireless information and stores the reference sensing information in storage 18. In the operating state, however, antenna section 112 obtains sequential wireless information including at least RSSI or CSI, and sensing unit 133 generates sequential sensing information and likewise stores the sequential sensing information in storage 18, State change extractor 15 then detects changes in state within sensing range 1003 or 1004 based on the difference between the reference sensing information and the sequential sensing information, and outputs the results as state change information. State change extractor 15 is one example of an estimator. The state change information is one example of first information.

Condition determiner 16 determines whether the sensing information output by sensing unit 133 or the state change information calculated by state change extractor 15 satisfies a predetermined condition that has been set in advance, Condition determiner 16 is one example of an estimator.

Controller 17 performs predetermined control based on the determination result obtained by condition determiner 16. Specifically, controller 17 performs predetermined control such as starting, stopping, or changing the predetermined operation of a control target (home appliance), based on whether the sensing information calculated by sensing unit 133 or the state change information calculated by state change extractor 15 satisfies the predetermined condition.

In the case of controlling the brightness of the display of a home appliance, for example, when the sensing result indicates that there are people present in the sensing range, control can be performed to increase the brightness of the display and when there are no people present in the sensing range, control can be performed to decrease the brightness of the display. This can reduce unnecessary power consumption when there are no people present.

Moreover, it is possible to suppress unnecessary notification by sending a notification only when there are people present in the sensing range.

With wireless unit 114 transmitting and receiving signals to and from wireless main unit 11, sensing device 10 can perform communication over external networks excluding the network over which wireless main unit 11 communicates with sensing device 10.

Wireless unit 224 joins wireless main unit 11 via antenna section 212 and can transmit and receive wireless signals via Wi-Fi to and from wireless main unit 11. Wireless unit 224 may be communicable with wireless unit 114 of sensing device 10 without joining wireless main unit 11. Wireless unit 224 can transmit signals from CSI transmitter 234 to wireless unit 114. Stated differently, wireless unit 224 may operate as a wireless main unit and wireless unit 114 may operate as a wireless subunit. Specifically, wireless unit 224 transmits either a signal transmitted to wireless unit 114 or a signal transmitted via broadcast. More specifically, wireless unit 224 transmits predefined packets such as beacon signals, ACK, NDP, NULL, and data packets from antenna section 212. Wireless unit 224 is one example of a first subunit. One of RSSI and CSI is one example of wireless information.

### [Operation]

Next, the operation of sensing device 10 according to Embodiment 2 will be described.

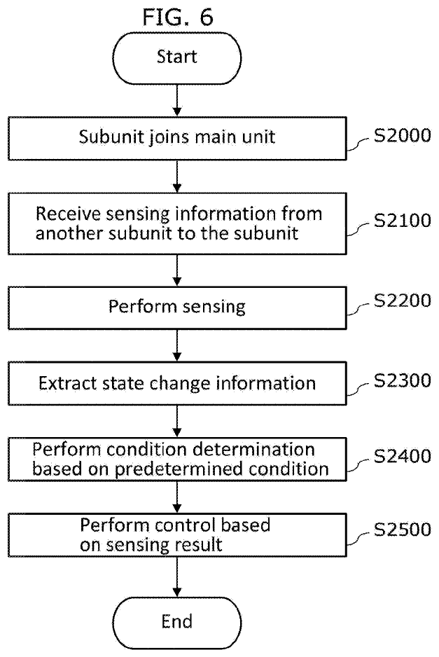

FIG. 6 is a flowchart illustrating one example of a sensing method employed by the sensing device according to Embodiment 2.

First, wireless unit 114 joins wireless main unit 11 (S2000), Specifically, in the joining, wireless unit 114 transmits a connection request to the access point of wireless main unit 11, and after the authentication and connection process, a relationship will be established and communication is allowed over the network. This brings wireless unit 114 and wireless main unit 11 into a communicable state.

Also, in this case, wireless unit 224 may join wireless main unit 11. Specifically, in the joining, wireless unit 224 transmits a connection request to the access point of wireless main unit 11, and after the authentication and connection process, a relationship will be established and communication is allowed over the network. This brings wireless unit 224 and wireless main unit 11 into a communicable state.

When wireless unit 114 and wireless unit 224 are each communicable with wireless main unit 11 that is the same main unit, wireless unit 114 and wireless unit 224 may be subunits that are communicable with each other. In other words, in this case, wireless unit 114 operates as a wireless subunit when communicating with wireless main unit 11 and operates as a wireless main unit when communicating with wireless unit 224. In other words, in this case, the relationship between wireless unit 114 and wireless unit 224 is a relationship in which wireless unit 114 operates as a wireless main unit and wireless unit 224 operates as a wireless subunit. Alternatively, wireless unit 114 may operate as a wireless subunit and wireless unit 224 may operate as a wireless main unit. Wireless unit 114 and wireless unit 224, whose communication has been enabled, can mutually transmit and receive signals. Wireless unit 114 and wireless unit 224 may be connectable to each other without one of wireless unit 114 and wireless unit 224 joining the wireless main unit. Wireless unit 114 and wireless unit 224 may be connectable to each other without both wireless unit 114 and wireless unit 224 joining the wireless main unit.

Subsequently, sensing device 10 receives a signal transmitted from sensing device 12 that is a subunit different from sensing device 10 (S2100). In this case, the signal received by sensing device 10 is, for example, wireless information (e.g., reception information) from sensing device 12. The signal received by sensing device 10 may be based on sensing information resulting from sensing using wireless information between wireless main unit 11 and sensing device 12.

Subsequently, sensing device 10 performs sensing in sensing range 1004 (S2200). Specifically, wireless unit 114 receives wireless information (e.g., reception information) from wireless unit 224 via antenna section 112 and obtains at least RSSI or CSI from the received signal. Sensing unit 133 then outputs, as sensing information (sequential sensing information), the state of a living body within sensing range 1004 based on at least the obtained RSSI or CSI. The state of a living body is at least one of detection of the presence or absence of a living body, positioning, distance measurement, posture detection, or personal identification.

Sensing unit 133 may output the state of a living body within sensing range 1003 as sensing information (sequential sensing information), based on at least the obtained RSSI or CSI, or may output, as sensing information, the sensing information obtained using wireless information obtained using wireless signals from sensing range 1003 together with the sensing information obtained using wireless information obtained using wireless signals from sensing range 1004.

Sensing device 10 extracts changes in a state regarding the living body in the sensing range (at least one of sensing range 1003 or sensing range 1004) (S2300). Specifically, state change extractor 15 reads out, from storage 18, reference sensing information previously stored in storage 18. The reference sensing information is sensing information obtained by performing sensing in the sensing range in the reference state. Sensing device 10 then calculates the difference between the sequential sensing information output in step S2200 and the reference sensing information and extracts, as state change information, state changes indicated by the difference.

Sensing device 10 references the sequential sensing information output in step S2200 or the state change information extracted in step S2300 and performs condition determination under a predetermined condition (S2400). Specifically, using a predetermined condition previously stored in storage 18, condition determiner 16 determines whether the sequential sensing information or the state change information satisfies the predetermined condition.

When the distance from sensing device 10 to the living body within sensing range 1003, 1004 can be obtained as sequential sensing information, for example, condition determiner 16 determines whether the distance indicated by the sensing information that has been output is greater than or equal to a threshold value, based on the predetermined condition. Condition determiner 16 may determine whether state change extractor 15 has extracted that the distance indicated by the output sensing information has changed from the state in which the distance exceeds the threshold value to the state in which the distance is less than or equal to the threshold value. In other words, condition determiner 16 may determine whether the distance of the living body has changed from being greater than or equal to the threshold value to being less than or equal to the threshold value. When the state of the presence or absence of the living body within sensing range 1003, 1004 (first information) can be obtained as the output sensing information, condition determiner 16 determines whether the state indicated by the output sensing information indicates the presence of the living body. Condition determiner 16 may determine whether state change extractor 15 has extracted that the state has changed from the state in which the living body is absent to the state in which the living body is present, i.e., whether the state has changed from being absent to being present.

Sensing device 10 performs predetermined control based on the result of the condition determination in step S2400 (S2500). Specifically, controller 17 performs control of sensing device 10 based on the determination result of the condition determination, When a living body is present in both sensing range 1003 and sensing range 1004 in step S2400, for example, since the sensing result obtained by performing sensing in sensing range 1003 is “present” and the sensing result obtained by performing sensing in sensing range 1004 is “present”, condition determiner 16 can determine that people are present in the overlapping range of sensing range 1003 and sensing range 1004 by layered calculation of the sensing results. When it is determined that living bodies are present in the overlapping range, controller 17 may perform predetermined control that is third control. When condition determiner 16 determines that there is no living body in the overlapping range, however, controller 17 may perform fourth control different from the third control.

In Embodiment 2 described above, in response to the wireless signal from CSI transmitter 234, sensing unit 133 of wireless unit 114 performs sensing based on the wireless signal from CSI transmitter 234, but sensing unit 233 of wireless unit 224 may perform, in response to a wireless signal from CSI transmitter 134, sensing based on the wireless signal from CSI transmitter 134.

Sensing device 10 may perform control of sensing device 10 based on one of the sensing result obtained by wireless unit 114 or the sensing result obtained by wireless unit 224, or may perform control of sensing device 10 using both the sensing result obtained by wireless unit 114 and the sensing result obtained by wireless unit 224.

### [Advantageous Effects]

Sensing system 2 according to the present embodiment includes: wireless unit 114 configured to be capable of transmitting a wireless signal via Wi-Fi; wireless unit 224 configured to receive a wireless signal transmitted from wireless unit 114 and obtain at least one of RSSI or CSI from the received wireless signal; an estimator that performs sensing of living body 50 based on at least one of the RSSI or CSI and outputs sensing information or state change information; and controller 17 that performs predetermined control based on the result of determination of whether the sensing information or the state change information satisfies a predetermined condition.

According to the above configuration, sensing device 10 can output a plurality of sensing information items based on a plurality of sensing ranges 1003 and 1004. As a result, compared to sensing information based on a single sensing range, it is possible to increase the amount of information in sensing information or expand the sensing range, which is expected to improve the accuracy of sensing living body 50. Furthermore, based on the sensing information based on the plurality of sensing ranges 1003 and 1004, the accuracy of the determination results under a predetermined condition using first information is improved, enabling the provision of a sensing device that can achieve more appropriate control.

### Variation of Embodiment 2

In the present embodiment, sensing device 10 performs sensing using a wireless signal obtained from each of sensing range 1003 and sensing range 1004, but may perform sensing using also a wireless signal obtained from sensing range 1005 (see FIG. 4) that is set for wireless main unit 11 and sensing unit 224 of sensing device 12. For example, sensing device 10 may output, from sensing unit 233, wireless information obtained using a wireless signal from sensing range 1005, transmit the wireless information to wireless unit 114 via antenna section 212, and output the wireless information as first information.

With the above configuration, since sensing device 10 can output sensing information based on three or more sensing ranges that are sensing ranges 1003 to 1005, compared to sensing information based on a single sensing range or two sensing ranges, it is possible to increase the amount of information in sensing information or expand the sensing range, which is expected to improve the accuracy of sensing living body 50, Furthermore, owing to the sensing information based on the plurality of sensing ranges 1003 to 1005, the accuracy of the results of the determination performed under a predetermined condition using the first information is improved, enabling the provision of a sensing device that can achieve more appropriate control.

### Other Embodiments

In Embodiments 1 and 2 described above, controller 17 can perform control based on each of a plurality of information items obtained from at least two sensing ranges. In the case of Embodiment 1, the plurality of first information items include: information as a first sensing result obtained through sensing based on a wireless signal obtained from sensing range 1000; and information as a second sensing result obtained through sensing based on a wireless signal obtained from sensing range 1002. In the case of Embodiment 2, the plurality of first information items include: information as a first sensing result obtained through sensing based on a wireless signal obtained from sensing range 1003; and information as a second sensing result obtained through sensing based on a wireless signal obtained from sensing range 1004. Furthermore, in the case of the variation of Embodiment 2, the plurality of first information items include: information as a first sensing result obtained through sensing based on a wireless signal obtained from sensing range 1003; information as a second sensing result obtained through sensing based on a wireless signal obtained from sensing range 1004; and information as a third sensing result obtained through sensing based on a wireless signal obtained from sensing range 1005.

When (i) one first information item among the plurality of first information items satisfies a predetermined condition and other first information satisfies the predetermined condition, for example, controller 17 performs first control. When one first information satisfies the predetermined condition and other first information does not satisfy the predetermined condition, controller 17 performs second control. When one first information does not satisfy the predetermined condition and other first information satisfies the predetermined condition, controller 17 may perform third control. Thus, combining a plurality of first information items to perform determination increases options for control operations, and appropriate control in accordance with scenes can be achieved.

Hereinafter, description is provided based on the configuration according to Embodiment 1. In the case of applying the configuration according to Embodiment 2, sensing range 1000 can be read as sensing range 1003 and sensing range 1002 can be read as sensing range 1004.

For example, the case where one first information satisfies a predetermined condition is regarded as the situation where controller 17 can determine that living body 50 is present in sensing range 1002, and the case where other first information satisfies the predetermined condition is regarded as the situation where controller 17 can determine that living body 50 is present in sensing range 1000.

In the case, when one first information satisfies the predetermined condition and other first information satisfies the predetermined condition, controller 17 may determine that living body 50 is present in an area in which sensing range 1000 and sensing range 1002 overlap each other.

When one first information satisfies the predetermined condition and other first information does not satisfy the predetermined condition, controller 17 can determine that living body 50 is present in a specific area within sensing range 1002 and is not present in sensing range 1000. Accordingly, controller 17 may determine that living body 50 is present in an area, within sensing range 1002, different from sensing range 1000.

When one first information does not satisfy the predetermined condition and other first information satisfies the predetermined condition, controller 17 can determine that living body 50 is present in a specific area within sensing range 1000 and is not present in sensing range 1002. Accordingly, controller 17 may determine that living body 50 is present in an area, within sensing range 1000, different from sensing range 1002.

When either one first information or other first information satisfies the predetermined condition, controller 17 may determine that living body 50 is present in an area combining sensing range 1000 and sensing range 1002.

Since controller 17 can identify in more details an area in which living body 50 is present based on whether one first information satisfies the predetermined condition and whether other first information satisfies the predetermined condition, flexible control of a control target in accordance with the presence of living body 50 can be achieved.

In the present embodiment, by changing the installation position of wireless main unit 11, sensing range 1000 may be dynamically changed. As a result, it is possible to adjust the sensing range flexibly in accordance with user's environment and needs.

Furthermore, controller 17 may assign weights to one first information and other first information based on their respective reliabilities and importances. Controller 17 can achieve highly accurate and adaptive control by determining the control operation of the control target based on the result of the weighting.

As described above, sensing device 10 according to Embodiment 2 includes wireless unit 114 that can transmit and receive wireless signals via Wi-Fi in communications with wireless main unit 11 to be connected to an external network.

According to the above configuration, the wireless sensing device can define its sensing range and utilize the sensing result while independently joining surrounding Wi-Fi access points.

In each of the embodiments, each element may be configured by dedicated hardware or implemented by executing a software program suitable for the element. Each element may be implemented by a program executor such as a CPU or a processor reading and executing a software program recorded on a recording medium such as a hard disk or semiconductor memory.

The present disclosure can be implemented not only as a sensing device including such characteristic elements, but also as a sensing method including, as steps, the characteristic elements included in the sensing device. The present disclosure can be also implemented as a computer program causing a computer to execute each characteristic step included in such a method. Needless to say, such a computer program can be distributed via a computer-readable non-transitory recording medium such as a CD-ROM or a communication network such as the Internet.

### INDUSTRIAL APPLICABILITY

The present disclosure can be used in sensing devices and sensing methods that estimate the distances or positions of living bodies using wireless signals, and particularly in measuring devices that measure the distances and positions of living bodies, home appliances that perform control based on the distances and positions of living bodies, and surveillance devices that detect the intrusion of living bodies.

1. A sensing system for sensing a living body using a wireless signal, the sensing system comprising:
a first subunit and a second subunit configured to be capable of mutually transmitting and receiving a wireless signal;
an estimator that outputs first information regarding sensing of the living body; and
a controller, wherein
the first subunit is configured to intercept a wireless signal that the second subunit uses to communicate with a wireless main unit, to obtain wireless information included in the wireless signal,
the estimator outputs the first information based on the wireless information obtained, and
the controller performs predetermined control based on the first information output by the estimator.

2. The sensing system according to claim 1, wherein
the first subunit and the second subunit are provided in a single device.

3. The sensing system according to claim 1, wherein
the wireless information includes: information to be transmitted from the second subunit to the first subunit; and information to be transmitted from the second subunit to the first subunit via the living body.

4. The sensing system according to claim 1, wherein
the first information includes sensing information regarding a state of the living body.

5. The sensing system according to claim 1, further comprising:
the wireless main unit, wherein
the wireless main unit is configured to be capable of transmitting a wireless signal to each of the first subunit and the second subunit.

6. The sensing system according to claim 5, wherein
the first subunit is configured to obtain wireless information from each of the wireless main unit and the second subunit, and
the estimator obtains the first information based on a first sensing range and a second sensing range, the first sensing range corresponding to the first subunit and the wireless main unit, the second sensing range corresponding to the first subunit and the second subunit.

7. The sensing system according to claim 1, wherein
the estimator includes a sensing unit and a condition determiner,
the sensing unit is configured to output sensing information based on the wireless information,
the condition determiner determines whether the sensing information output by the sensing unit satisfies a predetermined condition; and
the first information includes information corresponding to a determination result obtained by the condition determiner.

8. The sensing system according to claim 7, wherein
the estimator includes a state change extractor that extracts a change in a state of the living body in an operating state,
the sensing unit is configured to output sequential sensing information that is the sensing information in the operating state,
the state change extractor extracts, as state change information, a difference between the sequential sensing information and reference sensing information that is the sensing information in a reference state, and
the first information includes the state change information.

9. A sensing method to be executed by a sensing system for sensing a living body using at least one processor, the sensing system including a first subunit and a second subunit configured to be capable of mutually transmitting and receiving a wireless signal, the sensing method comprising:
outputting first information regarding sensing of the living body;
intercepting a wireless signal that the second subunit uses to communicate with a wireless main unit, to obtain wireless information included in the wireless signal;
outputting the first information based on the wireless information obtained; and
performing predetermined control based on the first information output.

10. A non-transitory computer-readable recording medium having a program stored therein, the program causing at least one computer to execute the sensing method according to claim 9.
